(19) United States
(12) Patent Application Publication
(10) Pub. No.: US 2020/0240028 A1
(43) Pub. Date: Jul. 30, 2020

(54) WATER SPLITTING DEVICE

(71) Applicants: FUJIFILM Corporation, Tokyo (JP); Japan Technological Research Association of Artificial Photosynthetic Chemical Process, Tokyo (JP)

(72) Inventors: Hiroyuki KOBAYASHI, Tokyo (JP); Taisei NISHIMI, Tokyo (JP); Hiroshi NAGATE, Tokyo (JP)

(73) Assignees: FUJIFILM Corporation, Tokyo (JP); Japan Technological Research Association of Artificial Photosynthetic Chemical Process, Tokyo (JP)

(21) Appl. No.: 16/850,725

(22) Filed: Apr. 16, 2020

Related U.S. Application Data
(63) Continuation of application No. PCT/JP2018/038268, filed on Oct. 15, 2018.

(30) Foreign Application Priority Data
Oct. 17, 2017 (JP) 2017-201182

(51) Int. Cl. C25B 13/08; C25B 1/10; B01D 69/10; B01D 67/00; C25B 9/08

(52) U.S. Cl. CPC C25B 13/08; C25B 1/10; B01D 69/10; B01J 35/004; C25B 9/08; B01D 2325/36; B01D 67/0006

(57) ABSTRACT

An object of the invention is to provide a water splitting device having a low electrolysis voltage and excellent gas separation performance. The water splitting device of the invention is a water splitting device that generates gases from the positive electrode and the negative electrode, the water splitting device including: a bath to be filled with an electrolytic aqueous solution; the positive electrode and the negative electrode disposed in the bath; and a polymer membrane that is ion-permeable and is disposed between the positive electrode and the negative electrode in order to separate the electrolytic aqueous solution filling the bath into the positive electrode side and the negative electrode side, wherein the positive electrode and the negative electrode are installed at a predetermined distance from the polymer membrane, and the moisture content of the polymer membrane is 40% or more.

### CROSS-REFERENCE TO RELATED APPLICATIONS

This application is a Continuation of PCT International Application No. PCT/JP2018/038268 filed on Oct. 15, 2018, which claims priority under 35 U.S.C. § 119(a) to Japanese Patent Application No. 2017-201182 filed on Oct. 17, 2017. The above application is hereby expressly incorporated by reference, in its entirety, into the present application.

### BACKGROUND OF THE INVENTION

### 1. Field of the Invention

The present invention relates to a water splitting device.

### 2. Description of the Related Art

Conventionally, technologies for decomposing a liquid such as water by utilizing the energy of electricity or light and thereby producing a gas have been known. In particular, from the viewpoint of reducing carbon dioxide emission and making clean energy, attention has been focused on technologies for producing hydrogen and oxygen by splitting water using a photocatalyst by utilizing solar energy.

Regarding such a water splitting device for producing hydrogen and oxygen, JP2016-144804A discloses a water splitting reaction device having a photocatalyst electrode and a counter electrode immersed in an electrolyte aqueous solution, in which the electrolyte aqueous solution is separated by a diaphragm (ion-exchange membrane) into the photocatalyst electrode side and the counter electrode side (paragraph 0023, FIG. 9).

### SUMMARY OF THE INVENTION

In recent years, there has been a demand for more efficient production of gases, and specifically, there is a demand for a water splitting device which can lower the electrolysis voltage at the time of splitting water and has excellent performance of separating between a gas generated from a positive electrode and a gas generated from a negative electrode.

The inventors of the present invention performed splitting of water using the device described in JP2016-144804A, and found that the electrolysis voltage is increased, or the gas separation performance is insufficient.

Therefore, it is a problem of the present invention to provide a water splitting device having a low electrolysis voltage and excellent gas separation performance.

The present inventors have conducted a thorough investigation on the problems described above, and as a result, the inventors found that in a case in which a polymer membrane having a moisture content having a predetermined value or more is disposed between the positive electrode and the negative electrode, the electrolysis voltage is low, and the gas separation performance is excellent. Thus, the present invention was completed.

That is, the present inventors found that the above-described problems can be solved by the following configuration.

[1]

A water splitting device for generating gases from a positive electrode and a negative electrode, the water splitting device comprising:

a bath to be filled with an electrolytic aqueous solution;

the positive electrode and the negative electrode disposed in the bath; and

a polymer membrane that is ion-permeable and is disposed between the positive electrode and the negative electrode in order to separate the electrolytic aqueous solution filling the bath into the positive electrode side and the negative electrode side,

wherein the positive electrode and the negative electrode are both installed at a predetermined distance from the polymer membrane, and

the polymer membrane has a moisture content of 40% or more.

[2] The water splitting device according to [1], wherein the water splitting device is a device generating gases from the positive electrode and the negative electrode by irradiating the positive electrode and the negative electrode with light.

[3] The water splitting device according to [1] or [2], wherein the polymer membrane has a moisture content of 60% or more.

[4] The water splitting device according to any one of [1] to [3], wherein the polymer membrane is obtained using a polymer film-forming composition including a component from which a main component of the polymer membrane is derived; and at least one of a monomer or a polymer other than the component from which the main component is derived, and

a sum of the contents of the monomer and the polymer is 15% by mass or less with respect to the total mass of the polymer film-forming composition.

[5] The water splitting device according to any one of [1] to [4], wherein the polymer membrane is supported by a support.

[6] The water splitting device according to any one of [1] to [5], wherein the proportion of an area of a portion in which the polymer membrane comes into contact with the electrolytic aqueous solution with respect to an area of a portion in which the positive electrode or the negative electrode comes into contact with the electrolytic aqueous solution is 0.5 or more.

[7] The water splitting device according to any one of [1] to [6], wherein the polymer membrane is non-porous.

[8] The water splitting device according to any one of [1] to [7], wherein a polymer as a main component of the polymer membrane has a hydrophilic group.

[9] The water splitting device according to any one of [1] to [8], wherein the water splitting device is a device that irradiates the positive electrode and the negative electrode with light and thereby generates gases from the positive electrode and the negative electrode, the positive electrode, the polymer membrane, and the negative electrode are arranged in series along the traveling direction of the light to be irradiated, and the light transmittance of the polymer membrane in a direction in series with the traveling direction of the light is 80% or higher in the wavelength range of 300 to 800 nm.

[10] The water splitting device according to [9], wherein the positive electrode and the negative electrode have different absorption edge wavelengths of the light, and an absorption edge wavelength of the light of the negative electrode is longer than an absorption edge wavelength of the light of the positive electrode.

[11] The water splitting device according to any one of [1] to [10], wherein at least one of the positive electrode or the negative electrode has a photocatalyst layer, and the photocatalyst layer includes at least one material selected from the group consisting of BiVO₄, Ta₃N₅, BaTaO₂N, and a CIGS compound semiconductor.

[12] The water splitting device according to any one of [1] to [11], wherein a gas generated from the positive electrode is oxygen, and a gas generated from the negative electrode is hydrogen.

As described below, according to the present invention, a water splitting device having a low electrolysis voltage and excellent gas separation performance can be provided.

### BRIEF DESCRIPTION OF THE DRAWINGS

FIG. 1 is a lateral view schematically illustrating a device 1 as an embodiment of the device of the present invention.

FIG. 2 is a lateral view schematically illustrating a device 100 as an embodiment of the device of the present invention.

FIG. 3 is a lateral view schematically illustrating a device 200 as an embodiment of the device of the present invention.

FIG. 4 is a lateral view schematically illustrating the electrode configuration of a device 300 as an embodiment of the device of the present invention.

FIG. 5 is a lateral view schematically illustrating an electrode configuration of a device 400 as an embodiment of the device of the present invention.

### DESCRIPTION OF THE PREFERRED EMBODIMENTS

Hereinafter, the device of the invention will be described.

A numerical value range represented using “to” in this invention means a range including the numerical values described before and after “to” as the lower limit and the upper limit.

According to the invention, (meth) acryl means both acryl and methacryl, and (meth)acrylate means both acrylate and methacrylate.

The device of the present invention is a water splitting device (hereinafter, also referred to as “device”) that generates gases from a positive electrode and a negative electrode, the device comprising: a bath for filling an electrolytic aqueous solution; and the positive electrode and the negative electrode disposed in the bath; and a polymer membrane that is ion-permeable, the polymer membrane being disposed between the positive electrode and the negative electrode in order to separate the electrolytic aqueous solution filled in the bath into the positive electrode side and the negative electrode side, wherein the positive electrode and the negative electrode are both installed at a predetermined distance (preliminarily determined distance) from the polymer membrane, and the moisture content of the polymer membrane is 40% or more.

The device of the present invention has low electrolysis voltage and excellent gas separation performance. Although the details of the reasons for this have not been clarified, it is assumed that the reasons are generally as follows.

A polymer membrane having a high moisture content has a high affinity for water, and therefore, such a polymer membrane does not easily inhibit permeation of the ions included in the electrolytic solution. As a result, it is speculated that the ion exchange rate was enhanced, and the electrolysis voltage of the device at the time of splitting water was lowered.

Furthermore, since a polymer membrane having a high moisture content is in a so-called gel state, the polymer membrane almost does not have any pores having a size which allows passage of gases (bubbles) that are generated from the respective electrodes and dissolved in the electrolytic solution. Therefore, it is speculated that the gases generated at the respective electrodes are not easily mixed with each other, and the gas separation performance is enhanced.

Hereinafter, the device of the present invention will be described in detail in each embodiment with reference to the drawings.

### First Embodiment

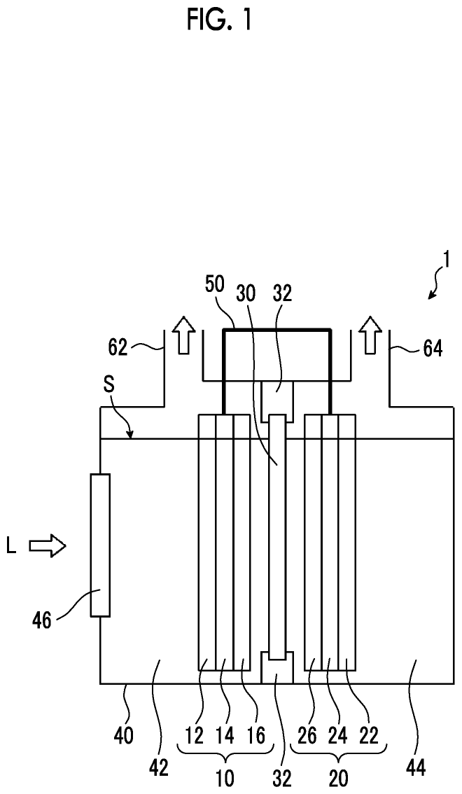

FIG. 1 is a lateral view schematically illustrating a device 1 as an embodiment of the device of the present invention, and in the present specification, the device 1 illustrated in FIG. 1 is also referred to as first embodiment. The device 1 is a device that generates gases from a positive electrode 10 and a negative electrode 20 by means of irradiation with light L. Specifically, in a case in which an electrolytic solution S that will be described later contains water as a main component, water is split by the light L, oxygen is generated from the positive electrode 10, and hydrogen is generated from the negative electrode 20.

As shown in FIG. 1, the device 1 has a bath 40 filled with an electrolytic solution S; a positive electrode 10 and a negative electrode 20 disposed in the bath 40; and a polymer membrane 30 disposed between the positive electrode 10 and the negative electrode 20 and inside the bath 40. The positive electrode 10, the polymer membrane 30, and the negative electrode 20 are disposed in series in this order along the traveling direction of the light L.

<Bath>

As shown in FIG. 1, at least a portion of one surface of the bath 40 is formed of a transparent member 46 so that the light L can be irradiated into the bath 40.

The inside of the bath 40 is partitioned by the polymer membrane 30 into a positive electrode chamber 42 that is on the side of the transparent member 46 and has the positive electrode 10 disposed therein, and a negative electrode chamber 44 that is on the side of the surface facing the transparent member 46 and has the negative electrode 20 disposed therein.

Regarding a specific example of the material that constitutes the bath 40, a material having excellent corrosion resistance (particularly, alkali resistance) is preferred, and examples thereof include poly(meth)acrylate, polycarbonate, polypropylene, polyethylene, polystyrene, and glass.

Specific examples of the material forming the transparent member 46 include poly(meth)acrylate and glass.

The term “transparent” in the present invention means that the light transmittance in the wavelength range of 380 nm to 780 nm is 60% or higher. Light transmittance is measured using a spectrophotometer. As the spectrophotometer, for example, V-770 (product name) manufactured by JASCO Corporation, which is an ultraviolet-visible spectrophotometer, is used.

(Electrolytic Solution)

As shown in FIG. 1, the inside of the bath 40 is filled with the electrolytic solution S, and at least a portion of each of the positive electrode 10, the negative electrode 20, and the polymer membrane 30 is immersed in the electrolytic solution S.

The electrolytic solution S is a solution obtained by dissolving an electrolyte in a liquid. As the liquid, water is preferred. Specific examples of the electrolyte include sulfuric acid, sodium sulfate, potassium hydroxide, potassium phosphate, and boric acid.

The pH of the electrolytic solution S is preferably 6 to 11, and more preferably 6 to 9. In a case in which the pH of the electrolytic solution S is within the range described above, there is an advantage that the electrolytic solution S can be handled safely. The pH of the electrolytic solution S can be measured using a known pH meter.

The concentration of the electrolyte in the electrolytic solution S is not particularly limited; however, it is preferable that the pH of the electrolytic solution S is in the above-described range.

<Positive Electrode>

The positive electrode 10 is disposed in the positive electrode chamber 42 at a predetermined distance from the polymer membrane 30. That is, the positive electrode 10 is provided at a position separated apart from the polymer membrane 30, and the electrolytic solution S is present between the positive electrode 10 and the polymer membrane 30. Here, the predetermined distance means a distance of the extent that the positive electrode 10 and the polymer membrane 30 do not come into contact, and for example, the predetermined distance can be adjusted to 1 to 100 mm.

The positive electrode 10 has a first substrate 12; a first conductive layer 14 disposed on the first substrate 12; and a first photocatalyst layer 16 disposed on the first conductive layer 14. The positive electrode 10 is disposed in the bath 40 (positive electrode chamber 42) such that the first substrate 12, the first conductive layer 14, and the first photocatalyst layer 16 are arranged in this order from the side that is irradiated with the light L.

In the example of FIG. 1, the positive electrode 10 has a flat plate shape; however, the shape is not limited to this. The positive electrode 10 may be in a punched metal form, a mesh form, or a lattice form, or the positive electrode 10 may be a porous body having penetrating pores.

The positive electrode 10 is electrically connected to the negative electrode 20 by a conducting wire 50. FIG. 1 shows an example in which the positive electrode 10 and the negative electrode 20 are connected by the conducting wire 50; however, the mode of connection is not particularly limited as long as the electrodes are electrically connected.

The thickness of the positive electrode 10 is preferably 0.1 to 5 mm, and more preferably 0.5 to 2 mm.

The absorption edge wavelength of light of the positive electrode 10 is preferably 500 to 800 nm.

Here, the absorption edge wavelength of light means a portion or an edge thereof in a continuous absorption spectrum, where the light absorptivity rapidly decreases in a case in which the wavelength becomes any longer, and the unit of the absorption edge wavelength of light is nm.

(First Substrate)

A first substrate 12 is a layer that supports the first conductive layer 14 and the first photocatalyst layer 16.

The first substrate 12 is preferably transparent in order to make the light L incident on the negative electrode 20. The definition of “transparent” is as described above.

Specific examples of the material forming the first substrate 12 include poly(meth)acrylate, glass, metal, and ceramic.

The thickness of the first substrate 12 is preferably 0.1 to 5 mm, and more preferably 0.5 to 2 mm.

(First Conductive Layer)

As the positive electrode 10 has the first conductive layer 14, electrons generated by the incidence of light L on the positive electrode 10 move to the second conductive layer 24 (will be described later) of the negative electrode 20 via the conducting wire 50.

The first conductive layer 14 is preferably transparent in order to make the light L incident on the negative electrode 20. The definition of “transparent” is as described above.

Specific examples of the material forming the first conductive layer 14 include ITO (indium tin oxide) and zinc oxide-based transparent conductive materials (such as Al:ZnO, In:ZnO, and Ga:ZnO). The notation of “metal atom:metal oxide” such as Al:ZnO means that a portion of the metal (Zn in the case of Al:ZnO) constituting the metal oxide has been substituted with metal atoms (Al in the case of Al:ZnO).

The thickness of the first conductive layer 14 is preferably 50 nm to 1 μm, and more preferably 100 to 500 nm.

(First Photocatalyst Layer)

In a case in which the positive electrode 10 is irradiated with the light L, electrons generated in the first photocatalyst layer 16 move to the first conductive layer 14. On the other hand, as the holes generated in the first photocatalyst layer 16 react with water, a gas (oxygen in the case of a water splitting reaction) is generated from the positive electrode 10.

The thickness of the first photocatalyst layer 16 is preferably from 100 nm to 10 μm, and more preferably from 300 nm to 2 μm.

Specific examples of the material constituting the first photocatalyst layer 16 can include oxides such as Bi₂WO₆, BiVO₄, BiYWO₆, In₂O₃ (ZnO)₃, InTaO₄, and InTaO₄:Ni (wherein the expression “compound:M” represents that an optical semiconductor is doped with M. The same applies hereinafter), TiO₂:Ni, TiO₂:Ru, TiO₂Rh, TiO₂:Ni/Ta (the expression “compound:M1/M2” indicates that the optical semiconductor is co-doped with M1 and M2. The same applies hereinafter), TiO₂:Ni/Nb, TiO₂:Cr/Sb, TiO₂:Ni/Sb, TiO₂:Sb/Cu, TiO₂:Rh/Sb, TiO₂:Rh/Ta, TiO₂:Rh/Nb, SrTiO₃:Ni/Ta, SrTiO₃:Ni/Nb, SrTiO₃:Cr, SrTiO₃:Cr/Sb, SrTiO₃:Cr/Ta, SrTiO₃:Cr/Nb, SrTiO₃:Cr/W, SrTiO₃:Mn, SrTiO₃:Ru, SrTiO₃:Rh, SrTiO₃:Rh/Sb, SrTiO₃:Ir, CaTiO₃:Rh, La₂Ti₂O₇:Cr, La₂Ti₂O₇:Cr/Sb, La₂Ti₂O₇:Fe, PbMoO₄:Cr, RbPb₂Nb₃O₁₀, HPb₂Nb₃O₁₀, PbBi₂Nb₂O₉, BiVO₄, BiCu₂VO₆, BiSn₂VO₆, SnNb₂O₆, AgNbO₃, AgVO₃, AgLi_{1/3}Ti_{2/3}O₂, AgLi_{1/3}Sn_{2/3}O₂, WO₃, BaBi₁₋ₓInₓO₃, BaZr₁₋ₓSnₓO₃, BaZr₁₋ₓGeₓO₃, and BaZr₁₋ₓSiₓO₃; acid nitrides such as LaTiO₂N, Ca_{0.25}La_{0.75}TiO_{2.25}N_{0.75}, TaON, CaNbO₂N, BaNbO₂N, CaTaO₂N, SrTaO₂N, BaTaO₂N, LaTaO₂N, Y₂Ta₂O₅N₂, (Ga₁₋ₓZnₓ)(N₁₋ₓOₓ), (Zn₁₊ₓGe)(N₂Oₓ) (wherein x represents a value of 0 to 1), and TiNₓO_{y}F_{z}; nitrides such as NbN and Ta₃N₅; sulfides such as CdS; selenides such as CdSe; Ln₂Ti₂S₂O₅ (Ln:Pr, Nd, Sm, Gd, Tb, Dy, Ho, and Er); and oxysulfide compounds including La and In (Chemistry Letters, 2007, 36, 854-855); however, the material is not limited to the materials listed here as examples.

Among these, from the viewpoints of optical absorption wavelength and quantum efficiency, it is preferable that the first photocatalyst layer 16 contains at least one material selected from the group consisting of BiVO₄, Ta₃N₅, and BaTaO₂N.

The first photocatalyst layer 16 may have a co-catalyst supported on its surface. In a case in which the co-catalyst is supported, the onset potential and the photocurrent density become satisfactory.

Specific examples of the co-catalyst include simple substances composed of Pt, Pd, Ni, Au, Ag, Ru, Cu, Co, Rh, Ir, Mn, Fe, or the like; and alloys obtained by combining these, and oxides thereof (for example, ruthenium oxide, iridium oxide, cobalt-iron composite oxide, rhodium oxide, nickel-iron composite oxide, and platinum oxide).

<Negative Electrode>

The negative electrode 20 is disposed in the negative electrode chamber 44 at a predetermined distance from the polymer membrane 30. That is, the negative electrode 20 is provided at a position separated apart from the polymer membrane 30, and the electrolytic solution S is present between the negative electrode 20 and the polymer membrane 30. Here, the predetermined distance means a distance of the extent that the negative electrode 20 and the polymer membrane 30 do not come into contact, and for example, the predetermined distance can be adjusted to 1 to 100 mm.

The negative electrode 20 has a second substrate 22; a second conductive layer 24 disposed on the second substrate 22; and a second photocatalyst layer 26 disposed on the second conductive layer 24. The negative electrode 20 is disposed in the bath 40 (negative electrode chamber 44) such that the second photocatalyst layer 26, the second conductive layer 24, and the second substrate 22 are arranged in this order from the side that is irradiated with the light L (that is, the polymer membrane 30 side).

In the example of FIG. 1, the negative electrode 20 has a flat plate shape; however, the shape is not limited to this. The negative electrode 20 may be in a punched metal form, a mesh form, or a lattice form, or the negative electrode 20 may be a porous body having penetrating pores.

The thickness of the negative electrode 20 is preferably 0.1 to 5 mm, and more preferably 0.5 to 2 mm.

The absorption edge wavelength of light of the negative electrode 20 is preferably 700 to 1,300 nm.

Here, the positive electrode 10 and the negative electrode 20 have different absorption edge wavelengths of light, and it is preferable that the absorption edge wavelength of light of the negative electrode 20 is longer than the absorption edge wavelength of light of the positive electrode 10. Thereby, it becomes easy for the negative electrode to absorb the light that has been transmitted through the positive electrode disposed at the front surface, and thus the light utilization efficiency per unit area can be increased.

(Second Substrate)

A second substrate 22 is a layer that supports a second conductive layer 24 and a second photocatalyst layer 26.

The second substrate 22 may or may not be transparent. Specific examples of the material forming the second substrate 22 include poly(meth)acrylate, glass, metal, and ceramic.

The thickness of the second substrate 22 is preferably 0.1 to 5 mm, and more preferably 0.5 to 2 mm.

(Second Conductive Layer)

The holes generated by the incidence of the light L on the negative electrode 20 (second photocatalyst layer 26) are gathered in the second conductive layer 24. As a result, the holes gathered in the second conductive layer 24 are recombined with the electrons transported from the first conductive layer 14 of the positive electrode 10, and thereby the retention of holes and electrons can be suppressed.

The material constituting the second conductive layer 24 is not particularly limited as long as the material has electrical conductivity, and examples thereof include metals such as Mo, Cr, and W; and alloys thereof.

The thickness of the second conductive layer 24 is preferably 100 nm to 2 μm, and more preferably 200 nm to 1 μm.

(Second Photocatalyst Layer)

In a case in which the negative electrode 20 is irradiated with the light L, holes generated in the second photocatalyst layer 26 move to the second conductive layer 24. On the other hand, as the electrons generated in the second photocatalyst layer 26 react with water, a gas (hydrogen in the case of a water splitting reaction) is generated from the negative electrode 20.

The thickness of the second photocatalyst layer 26 is preferably 100 nm to 10 μm, and more preferably 500 nm to 5 μm.

Examples of the material constituting the second photocatalyst layer 26 include oxides, nitrides, oxynitrides, and (oxy)chalcogenides, each containing at least one kind of metal atoms selected from the group consisting of Ti, V, Nb, Ta, W, Mo, Zr, Ga, In, Zn, Cu, Ag, Cd, Cr and Sn, and GaAs, GaInP, AlGaInP, CdTe, CuInGaSe, a CIGS compound semiconductor (compound semiconductor containing Cu, In, Ga, and Se as main materials), or a CZTS compound semiconductor (for example, Cu₂ZnSnS₄) is preferred; a CIGS compound semiconductor having a chalcopyrite crystal structure or a CZTS compound semiconductor such as Cu₂ZnSnS₄ is more preferred; while a CIGS compound semiconductor having a chalcopyrite crystal structure is particularly preferred.

The second photocatalyst layer 26 may have a co-catalyst supported on its surface. In a case in which the co-catalyst is supported, the water splitting efficiency becomes more satisfactory.

Specific examples of the co-catalyst include Pt, Pd, Ni, Ag, Ru, Cu, Co, Rh, Ir, Mn, and ruthenium oxide.

<Polymer Membrane>

The polymer membrane 30 is disposed between the positive electrode 10 and the negative electrode 20 so that ions included in the electrolytic solution S can freely enter and exit the positive electrode chamber 42 and the negative electrode chamber 44, but the gas generated at the positive electrode 10 and the gas generated at the negative electrode 20 do not mix.

The moisture content of the polymer membrane 30 is 40% or more, preferably 50% or more, more preferably 60% or more, and particularly preferably 70% or more. The upper limit of the moisture content of the polymer membrane 30 is preferably 90% or less, and more preferably 85% or less. When the moisture content of the polymer membrane 30 is 40% or more, a device having a low electrolysis voltage and excellent gas separation performance can be obtained as described above. When the moisture content of the polymer membrane 30 is 90% or less, the strength of the polymer membrane is excellent.

Here, the moisture content of the polymer membrane 30 is a value calculated by the following formula, based on the mass at the time of immersing the polymer membrane 30 in pure water (25° C.) for 24 hours (mass of the polymer membrane 30 after immersion) and the mass after drying the polymer membrane 30 after immersion in a vacuum at room temperature (25° C.) for 24 hours (mass of the polymer membrane 30 after drying).

Moisture content (%) of polymer membrane 30=100×[{(mass of polymer membrane 30 after immersion)−(mass of polymer membrane 30 after drying)}/(mass of polymer membrane 30 after immersion))]

The polymer membrane 30 is preferably non-porous. Thereby, it becomes difficult for the gases (bubbles) generated at the respective electrodes to permeate the polymer membrane 30, and thus the gas separation performance of the device 1 is enhanced.

Here, the term “non-porous” means a state in which pores cannot be found when an image obtained using a scanning electron microscope (SEM) and obtained by magnifying the surface of the polymer membrane 30 by 50,000 times is observed. As the scanning electron microscope, a device equivalent to SU8020 (product name) manufactured by Hitachi High-Technologies Corporation is used.

The polymer membrane 30 is preferably a polymer gel. In the present invention, a polymer gel is a product in which water is incorporated into a three-dimensional network structure. In a case in which the polymer membrane 30 is a polymer gel, the moisture content of the polymer membrane 30 increases.

The light transmittance of the polymer membrane 30 is preferably 80% or higher, more preferably 85% or higher, and particularly preferably 90% or higher, in the wavelength range of 300 to 800 nm. Thereby, it becomes easy for the light L to permeate the polymer membrane 30 and reach the negative electrode 20, and therefore, the decomposition efficiency for the electrolytic solution S at the negative electrode 20 increases.

For the measurement of the light transmittance of the polymer membrane 30, an ultraviolet-visible-near-red spectrophotometer (manufactured by JASCO Corporation, product name “V-670”) is used. Specifically, the measurement is performed with a white plate attached to a surface of the polymer membrane 30, the surface being on the opposite side of the irradiation surface. The light transmittance is calculated as the amount of transmitted light by integrating all the light transmitted in the wavelength range of 300 to 800 nm by means of an integrating sphere. The light transmittance of the polymer membrane 30 means the transmittance of light that is incident in a direction in series with the traveling direction of the light L (direction of the arrow indicating the light L in FIG. 1. Specifically, it means the transmittance of light that is incident perpendicularly to the surface of the polymer membrane 30).

The measurement of the light transmittance of the polymer membrane 30 is performed using the polymer membrane 30 in a swollen state, which is obtained by immersing the polymer membrane 30 in pure water (25° C.) for 24 hours.

The proportion of the area of the portion where the polymer membrane 30 comes into contact with the electrolytic solution S with respect to the area of the portion where the positive electrode 10 or the negative electrode 20 comes into contact with the electrolytic solution S is preferably 0.5 or more, more preferably 0.6 or more, and particularly preferably 0.7 or more. The upper limit of the proportion described above is preferably 0.9 or less, and more preferably 0.8 or less.

In a case in which the proportion is 0.5 or more, the amount of ions per unit area permeating the polymer membrane 30 can be reduced, and therefore, the permeation rate of the ions permeating the polymer membrane 30 increases. As a result, the decomposition efficiency of the electrolytic solution S is enhanced.

The polymer membrane 30 is obtained by using, for example, a polymer film-forming composition including a component from which a main component of the polymer membrane 30 is derived; and at least one of a monomer or a polymer other than the component from which the main component is derived.

As an example of a method for producing the polymer membrane 30, a method of applying the polymer film-forming composition on an arbitrary base material to form the polymer membrane 30, and then detaching the polymer membrane 30 from the base material may be mentioned. In a case in which the polymer film-forming composition includes a monomer, the polymer membrane 30 is obtained by polymerizing this monomer.

The component from which the main component of the polymer membrane 30 is derived (hereinafter, also referred to as “main component monomer”) is a component that forms the main skeleton of the polymer membrane 30 by polymerization.

Examples of the main component monomer include a monofunctional monomer. As the monofunctional monomer, a monofunctional monomer having a hydrophilic group (hydrophilic monofunctional monomer) is preferred.

Examples of the hydrophilic group include an amide group, a hydroxy group, a polyalkyleneoxy group, a sulfonic acid group, a phosphoric acid group, an amino group, a carboxy group, and salts thereof. Among them, a nonionic hydrophilic group such as an amide group, a hydroxy group, or a polyalkyleneoxy group, is preferred.

The hydrophilic monofunctional monomer has one polymerizable group. The type of the polymerizable group is not particularly limited, and examples thereof include a radical polymerizable group and a cationic polymerizable group. More specific examples include a (meth)acryloyl group, a vinyl group, an allyl group, an epoxy group, and an oxetane group.

The main component monomers may be used singly or in combination of two or more kinds thereof.

Specific examples of the main component monomer include compounds having a hydrophilic group such as an amide group, a hydroxy group, a polyalkyleneoxy group, a sulfonic acid group, a phosphoric acid group, an amino group, a carboxy group, and salts thereof, such as (meth)acrylic acid and salts thereof (for example, alkali metal salts and amine salts), itaconic acid and salts thereof (for example, alkali metal salts and amine salts), allylamine and hydrohalogenic acid salts thereof, 3-vinylpropionic acid and salts thereof (for example, alkali metal salts and amine salts), vinylsulfonic acid and salts thereof (for example, alkali metal salts and amine salts), vinylstyrene sulfonic acid and salts thereof (for example, alkali metal salts and amine salts), 2-sulfoethylene (meth)acrylate and salts thereof (for example, alkali metal salts and amine salts), 3-sulfopropylene (meth)acrylate and salts thereof (for example, alkali metal salts and amine salts)), 2-acrylamido-2-methylpropane sulfonic acid and salts thereof (alkali metal salts and amine salts), acid phosphooxy polyoxyethylene glycol mono (meth)acrylate, allylamine and hydrohalogenic acid salts thereof, and 2-trimethylaminoethyl (meth)acrylate and hydrohalogenic acid salts thereof.

2-Hydroxyethyl (meth)acrylate, (meth)acrylamide, N-monomethylol (meth)acrylamide, N-dimethylol (meth)acrylamide, N-vinylpyrrolidone, N-vinylacetamide, allylamine and hydrohalogenic acid salts thereof, polyoxyethylene glycol mono (meth)acrylate, monomers having an amino acid skeleton in the molecule (for example, N-methacryloyloxyethylcarbamic acid and aspartic acid), monomers having a sugar skeleton in the molecule (for example, glycoxyethyl methacrylate), and the like can also be used.

As a monomer other than the main component monomer (hereinafter, also referred to as “other monomer”), which can be included in the polymer film-forming composition, a polyfunctional monomer having two or more polymerizable groups (so-called crosslinking agent) may be mentioned. In a case in which the polymer film-forming composition contains a polyfunctional monomer, a polymer membrane 30 having a three-dimensional network structure is easily obtained, and therefore, the moisture content of the polymer membrane 30 can be easily adjusted.

The other monomer may have the above-mentioned hydrophilic group.

Regarding the other monomer, one kind thereof may be used alone, or two or more kinds thereof may be used in combination.

In a case in which the polymer film-forming composition contains the other monomer, the content ratio of the other monomer with respect to the total mass of the main component monomer and the other monomer is preferably 0.05% by mass or more, and more preferably 0.1% by mass or more. The upper limit is not particularly limited; however, from the viewpoint that the moisture content is easily adjustable, the content ratio is preferably 10% by mass or less, and more preferably 5% by mass or less.

Specific examples of the other monomer include N,N-methylenebisacrylamide, triethylene glycol dimethacrylate, and the hydrophilic polyfunctional monomers described in WO 2013/011273 and WO 2014/050992.

As a polymer that can be included in the polymer film-forming composition, a polymer having a hydrophilic group is preferred. The definition of the hydrophilic group is as described above.

Specific examples of the polymer include synthetic polymers such as poly-N-vinylpyrrolidone, a modified polyvinyl alcohol, poly-N-vinylacetamide, polyacrylamide, and polyethylene glycol; polysaccharides and derivatives thereof, such as agarose, glucomannan, carrageenan, hydroxyethyl cellulose, carboxymethyl cellulose, and chondroitin sulfate, and alginic acid; and polyamino acids such as gelatin.

The polymers may be used singly or in combination of two or more kinds thereof.

In a case in which the polymer film-forming composition contains a polymer, the content ratio of the polymer with respect to the total mass of the main component monomer and the polymer is preferably 0.01% by mass or more, and more preferably 0.1% by mass or more. The upper limit is not particularly limited; however, from the viewpoint that the moisture content is easily adjustable, the content ratio is preferably 15% by mass or less, more preferably 10% by mass or less, and even more preferably 5% by mass or less.

In the polymer film-forming composition, the sum of the contents of the other monomer and the polymer is 40% by mass or less, more preferably 30% by mass or less, even more preferably 25% by mass or less, still more preferably 20% by mass or less, particularly preferably 15% by mass or less, and most preferably 10% by mass or less, with respect to the total mass (in this case, the total solid content) of the polymer film-forming composition. The lower limit is preferably 2% by mass or more, more preferably 3% by mass or more, and even more preferably 5% by mass or more.

In a case in which the content is 2% by mass or more, the moisture content of the polymer membrane 30 can be further increased, and therefore, an increase in the electrolysis voltage can be further suppressed. Furthermore, in a case in which the content is 40% by mass or less, since the polymer membrane thus obtainable undergoes less swelling, and the polymer membrane is easily self-supported, there is an advantage that handling of the polymer membrane becomes easy.

The sum of the contents of the other monomer and the polymer means, in a case in which only one of them is included, the content of only one of them.

The total solid content of the polymer film-forming composition means the total mass of components, except for the solvent, included in the polymer film-forming composition.

It is preferable that the polymer film-forming composition includes a solvent. Water is preferred as the solvent.

The content of the solvent is preferably 40 to 99% by mass, and more preferably 70 to 90% by mass, with respect to the total mass of the polymer film-forming composition.

The polymer film-forming composition may include components other than those described above. Examples of the other components include a polymerization initiator and a polymerization accelerator, and any known compounds can be used.

It is preferable that the polymer membrane 30 is a gel film containing a polymer as a main component and water. Here, the “polymer as the main component” means a polymer of the highest content among the total solid content constituting the polymer membrane 30. In particular, in a case in which the polymer membrane 30 is formed using the polymer film-forming composition described above, the “polymer as the main component” means a polymer obtainable by polymerizing the “component from which the main component is derived (main component monomer)” included in the polymer film-forming composition.

It is preferable that the polymer as the main component has the above-mentioned hydrophilic group, from the viewpoint that the polymer membrane 30 can easily hold water.

In the polymer membrane 30, the content of water is preferably 40 to 90% by mass, and more preferably 60 to 80% by mass, with respect to the total mass of the polymer membrane 30.

In the polymer membrane 30, the content of the polymer as the main component is preferably 60 to 99% by mass, and more preferably 80 to 99% by mass, with respect to the total solid content of the polymer membrane 30.

It is preferable that the polymer membrane 30 further includes at least one of a component derived from the above-described other monomer (that is, a form obtained as a result of reaction of the other monomer) included in the polymer film-forming composition, and the above-described polymer (that is, a polymer other than the polymer as the main component) included in the polymer film-forming composition.

As the polymer membrane 30, it is also possible to use a slide-ring material that is known to form a hydrogel having high strength (K. Ito et al., Adv. Mater., 13, 485 (2001)), a nanocomposite gel (K Haraguchi, et al., Adv Mater., 14, 1120 (2002)), a double network gel (Gong, J., et al, Adv. Mater. 15, 1155 (2003)), Tetra-PEG gel (T. Sakai et al., Macromolecules, 41, 14, 5379 (2008)), a hybrid gel (Z. Suo, et al, Nature, 489, 133 (2012)), and the like.

In order to enhance the strength, both ends of the polymer membrane 30 are supported by a support 32. The material forming the support 32 is not particularly limited, and examples thereof include a resin and a metal.

The example of FIG. 1 discloses an embodiment in which the support 32 holds portions of both edges of the polymer membrane 30; however, the invention is not limited to this. Specifically, the support may be formed over the entire surface of the polymer membrane 30. In this case, the support may be laminated with the polymer membrane 30 or may be present within the polymer membrane 30. From the viewpoint that the mechanical strength of the polymer membrane 30 is further enhanced, it is preferable that the support is present within the polymer membrane 30.

Regarding a method of laminating the polymer membrane 30 and the support, for example, a method of placing on the support a film obtainable before a film of the polymer film-forming composition is completely cured, or a polymer membrane 30 that has been completely cured, may be mentioned. As a method of introducing the support into the polymer membrane 30, for example, a method of applying or impregnating the support with the polymer film-forming composition and then performing a curing reaction may be mentioned.

In a case in which the support is formed over the entire surface of the polymer membrane, it is preferable that the support is porous (hereinafter, also referred to as “porous support”). Examples of the porous support include a synthetic woven fabric, a synthetic nonwoven fabric, a sponge-like film, and a film having fine through-holes. Examples of the material for forming the porous support include polyolefins (polyethylene, polypropylene, and the like), polyacrylonitrile, polyvinyl chloride, polyester, polyamide, and copolymers thereof; and polysulfone, polyether sulfone, polyphenylene sulfone, polyphenylene sulfide, polyimide, polyethermide, polyamide, polyamideimide, polyacrylonitrile, polycarbonate, polyacrylate, cellulose acetate, polypropylene, poly(4-methyl-1-pentene), polyvinylidene fluoride, polytetrafluoroethylene, polyhexafluoropropylene, polychlorotrifluoroethylene, and copolymers thereof.

In a case in which a polymer film-forming composition is applied or impregnated on a porous support, it is preferable that the porous support is formed of a material that does not absorb the irradiation wavelength of the energy rays used for the curing of the polymer film-forming composition. Specific examples of such a material include polycarbonate and poly(meth)acrylate.

In a case in which the polymer film-forming composition includes a component that forms the polymer membrane 30 by thermal polymerization, it is preferable that the porous support is formed of a material having high heat stability. Specific examples of such a material include polycarbonate.

The porous support may be subjected to a hydrophilization treatment such as a corona treatment, an ozone treatment, a sulfuric acid treatment, or a silane coupling agent treatment. That is, it is preferable that the support is hydrophilic.

In the case of using a porous support, it is preferable that the polymer film-forming composition has a property of being capable to penetrate into the porous support. For example, in a case in which the porous support is hydrophilic, and a component included in the polymer film-forming composition has a hydrophilic group, the polymer film-forming composition easily penetrates into the porous support.

From the viewpoint of having excellent light transmissibility, the porosity of the porous support is preferably 50% or higher, and more preferably 70% or higher. The upper limit of the porosity is preferably 90% or lower.

The porosity of the porous support can be determined as a ratio (%) of the area occupied by the pores per unit area, from a magnified image of the surface of the porous support obtained by means of an optical microscope. In a case in which the pores have a size of μm, a scanning electron microscope can be used.

The thickness of the porous support is preferably from 10 to 500 μm, and more preferably from 25 to 200 μm.

In a case in which the polymer membrane 30 does not have any ion-exchange group at all or has an ion-exchange group, the ion-exchange capacity is preferably 6 meq/g or less, and more preferably 3 meq/g or less. In a case in which the ion exchange capacity is 6 meq/g or less, since the movement of ions included in the electrolytic solution is less likely to be hindered by the ion exchange group, an increase in the electrolysis voltage can be further suppressed.

In addition, the ion exchange capacity of the polymer membrane 30 is calculated by the method described in the section of Examples that will be described later.

<Other Configurations>

The gas generated at the positive electrode 10 is collected through a first pipe 62 connected to the positive electrode chamber 42. The gas generated at the negative electrode 20 is collected through a second pipe 64 connected to the negative electrode chamber 44.

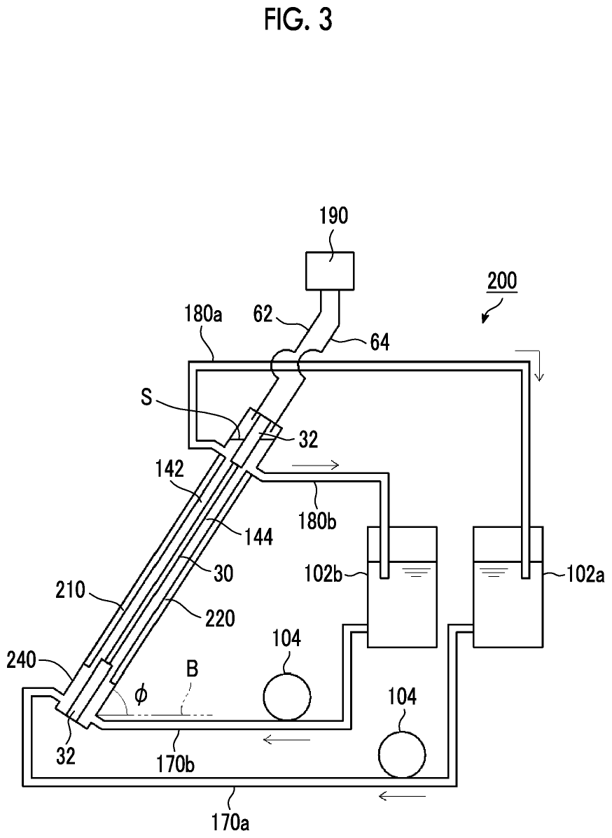

Although not shown in FIG. 1, similarly to FIG. 3 that will be described later, a supply pipe, a pump, and the like for supplying the electrolytic solution S may be connected to the bath 40.

FIG. 1 shows an example in which a portion of one surface of the bath 40 is formed of a transparent member 46; however, the entirety of the one surface of the bath 40 may be formed of a transparent member, or a surface other than the transparent member 46 of the bath 40 may be formed of a transparent member.

Although the example of FIG. 1 shows the case in which the light-receiving surface is the first substrate 12, the positive electrode 10 may be disposed such that the first photocatalyst layer 16 serves as the light-receiving surface. In this case, the first photocatalyst layer 16, the first conductive layer 14, and the first substrate 12 may be disposed in the bath 40 (positive electrode chamber 42) in this order from the side that is irradiated with the light L.

FIG. 1 shows a case in which the positive electrode 10 and the negative electrode 20 are not in contact with the inner wall surface of the bath 40; however, the present invention is not limited to this, and similarly to FIG. 3 that will be described later, at least one of the positive electrode 10 or the negative electrode 20 may be disposed to be in contact with the inner wall surface of the bath 40.

FIG. 1 shows the case in which both the positive electrode 10 and the negative electrode 20 are photocatalyst electrodes having a photocatalyst layer; however, the present invention is not limited to this, and only one of the positive electrode 10 or the negative electrode 20 may be a photocatalyst electrode.

FIG. 1 shows an example in which the device 1 generates gases from the positive electrode 10 and the negative electrode 20 only by irradiation with the light L; however, the present invention is not limited to this, and gases may be generated from the positive electrode 10 and the negative electrode 20 by utilizing application of a voltage from a power supply connected to the positive electrode 10 and the negative electrode 20, together with irradiation of light.

In the example of FIG. 1, the bath 40 in the device 1 is installed on a horizontal plane; however, similarly to FIG. 3 that will be described later, the bath 40 may be installed at a preliminarily determined angle with respect to the horizontal plane.

FIG. 1 shows an example in which the inside of the bath 40 is filled with the electrolytic solution S; however, the present invention is not limited to this, and the inside of the bath 40 may be filled with the electrolytic solution S at the time of driving the device 1.

### Second Embodiment

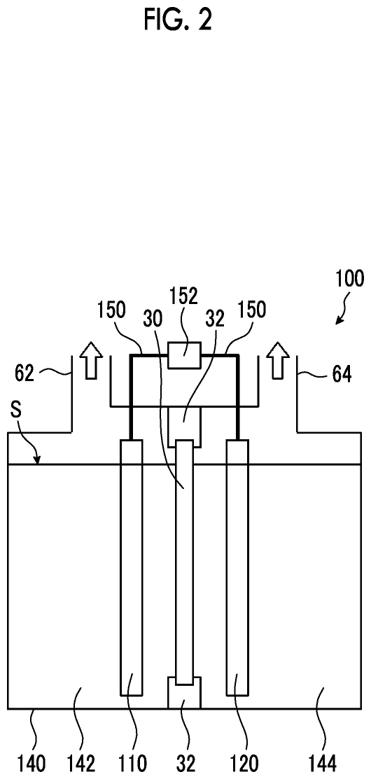

FIG. 2 is a lateral view schematically illustrating a device 100 as an embodiment of the device of the present invention, and in the present specification, the device 100 illustrated in FIG. 2 is also referred to as second embodiment.

The device 100 of FIG. 2 is different from the device 1 of FIG. 1 mainly from the viewpoint that the device 100 of FIG. 1 electrolyzes the electrolytic solution S, without irradiating the light L, but by applying a voltage to the positive electrode 110 and the negative electrode 120 by means of a power supply 152 that is connected to the electrodes via conducting wires 150, and thereby generates gases from the respective electrodes.

The device 100 of FIG. 2 requires the power supply 152 as compared with the device 1 of FIG. 1; however, the device 100 has an advantage that the configurations of the positive electrode 110, the negative electrode 120, and the bath 140 can be simplified.

In the following description on the device 100, the same reference numerals will be assigned to the configurations that are common to FIG. 1, and the description thereof may not be repeated herein. Furthermore, even if some members have different reference numerals, for the parts having the same configurations as that of FIG. 1, further description may not be repeated.

As shown in FIG. 2, the device 100 includes: a bath 140 filled with an electrolytic solution S; a positive electrode 110 and a negative electrode 120 disposed in the bath 140; and a polymer membrane 30 disposed between the positive electrode 110 and the negative electrode 120 and inside the bath 40. The positive electrode 110 and the negative electrode 120 are disposed at positions facing each other, with the polymer membrane 30 interposed therebetween.

The inside of the bath 140 is partitioned by the polymer membrane 30 into an positive electrode chamber 142 in which the positive electrode 110 is disposed, and a negative electrode chamber 144 in which the negative electrode 120 is disposed.

Specific examples of the material forming the bath 140 include a metal, a resin, and glass, and from the viewpoint of having superior corrosion resistance, a resin or glass is preferred.

The materials forming the positive electrode 110 and the negative electrode 120 are not particularly limited as long as the electrodes are respectively electrically conductive, and examples thereof include metals such as Pt, Ir, Au, Ru, Ni, Fe, and Co; and alloys thereof.

The positive electrode 110 and the negative electrode 120 are connected to a power supply 152 via conducting wires 150. The power supply 152 is not particularly limited as long as it is a device capable of generating gases from the positive electrode 110 and the negative electrode 120 by applying a voltage to the device 100.

The conducting wires 150 are similar to the conducting wires 50 of FIG. 1.

Although not shown in FIG. 2, similarly to FIG. 3 that will be described later, a supply pipe, a pump, and the like for supplying the electrolytic solution S may be connected to the bath 140.

FIG. 2 shows a case in which the positive electrode 110 and the negative electrode 120 are not in contact with the inner wall surface of the bath 140; however, the present invention is not limited to this, and it is also acceptable that at least one of the positive electrode 110 or the negative electrode 120 is disposed to be in contact with the inner wall surface of the bath 140, similarly to FIG. 3 that will be described later.

In the example of FIG. 2, the bath 140 in the device 100 is installed on a horizontal plane; however, it is also acceptable that the bath 140 is installed at a preliminarily determined angle with respect to the horizontal plane, similarly to FIG. 3 that will be described later.

### Third Embodiment

FIG. 3 is a lateral view schematically illustrating a device 200 as an embodiment of the device of the present invention, and in the present specification, the device 200 illustrated in FIG. 3 is also referred to as third embodiment.

The device 200 of FIG. 3 has a configuration generally similar to that of the device 100 of FIG. 2 as described above, except that the device 200 has a tank 102a, a tank 102b, a supply pipe 170a, a supply pipe 170b, a discharge pipe 180a, a discharge pipe 180b, a pump 104, and a gas chromatography mass spectrometer 190.

Since the device 200 of FIG. 3 has a gas chromatography mass spectrometer 190, the device 200 can be used for a composition analysis of the gases generated at the respective electrodes.

With regard to the device 200 of FIG. 3, the same reference numerals will be assigned to members similar to those of the device 100 in FIG. 2, and the description thereof will not be repeated, while those parts different from the device 100 of FIG. 2 will be mainly explained.

In the device 200 of FIG. 3, the electrolytic solution S stored in a tank 102a is supplied by a pump 104 into a positive electrode chamber 142 through a supply pipe 170a. The electrolytic solution S supplied into the positive electrode chamber 142 is returned to the tank 102a through a discharge pipe 180a. Similarly, the electrolytic solution S stored in a tank 102b is supplied by the pump 104 into a negative electrode chamber 144 through a supply pipe 170b. The electrolytic solution S supplied into the negative electrode chamber 144 is returned to the tank 102b through a discharge pipe 180b.

The example of FIG. 3 shows a case in which the tank 102a and the tank 102b are separately provided; however, the present invention is not limited to this, and the tank 102a and the tank 102b may be formed as one tank.

In the device 200 of FIG. 3, a bath 240 is disposed to be inclined at an angle φ with respect to the horizontal plane B. The angle φ is preferably 30 to 90 degrees, and more preferably 45 to 60 degrees. In a case in which the bath 240 is disposed to be inclined so as to have an angle φ, there is an advantage that the amount of incident sunlight per unit area can be increased.

The positive electrode 210 and the negative electrode 220 are respectively disposed to be in contact with the inner wall surface of the bath 240, without being in contact with the polymer membrane 30 supported by a support 32.

The gas generated from the positive electrode 210 (for example, oxygen) and the gas generated from the negative electrode 220 (for example, hydrogen) are subjected to a composition analysis using a gas chromatography mass spectrometer 190 through a first pipe 62 and a second pipe 64.

As the gas chromatography mass spectrometer 190, a known device (for example, product name “490 MICRO GC” of Agilent Technologies, Inc.) can be used.

FIG. 3 shows an example in which a composition analysis of the gases generated from the respective electrodes is performed using the gas chromatography mass spectrometer 190; however, the present invention is not limited to this. For example, the device 200 may be a device that does not have the gas chromatography mass spectrometer 190 and collects the gases generated at the respective electrodes through the first pipe 62 and the second pipe 64, similarly to FIG. 1 and FIG. 2.

### Fourth Embodiment

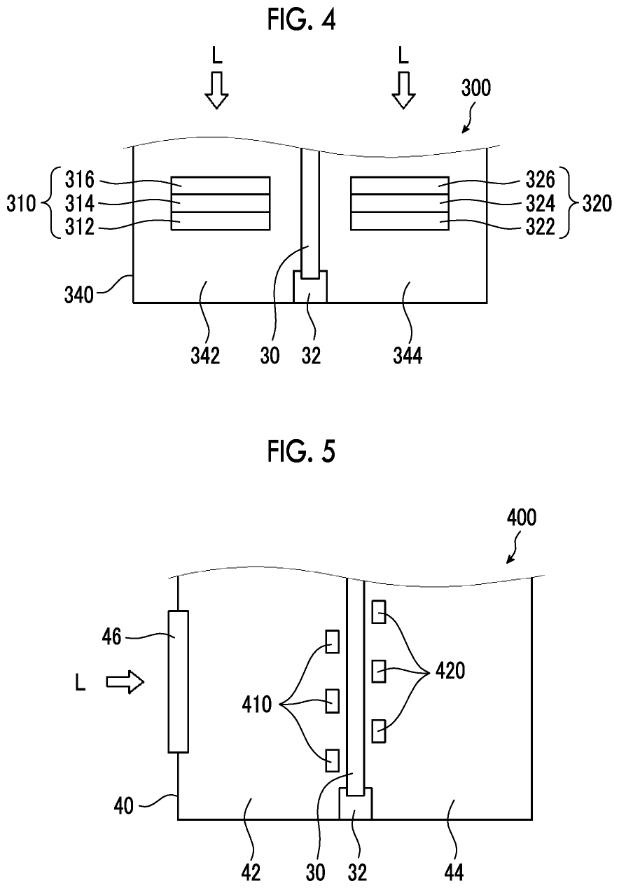

FIG. 4 is a lateral view schematically illustrating the electrode configuration of a device 300 as an embodiment of the device of the present invention, and in the present specification, the device 300 shown in FIG. 4 is also referred to as fourth embodiment.

The device 300 of FIG. 4 is mainly different from the device 1 of FIG. 1 in that a positive electrode 310, a polymer membrane 30, and a negative electrode 320 are arranged in a direction orthogonally intersecting the traveling direction of light L.

In FIG. 4, the same reference numerals as those in FIG. 1 will be assigned to configurations that are common to FIG. 1, and the description thereof will not be repeated. Furthermore, even if some members have different reference numerals, for the parts having the same configurations as those of FIG. 1, further description will not be repeated. Other configurations illustrated in FIG. 1 can also be employed in the device 300 of FIG. 4, and the description and depiction thereof may not be repeated.

The positive electrode 310 has a first substrate 312, a first conductive layer 314 disposed on the first substrate, and a first photocatalyst layer 316 disposed on the second conductive layer 314. The positive electrode 310 is disposed in the bath 340 (positive electrode chamber 342) such that the first photocatalyst layer 316, the second conductive layer 314, and the first substrate 312 are arranged in this order from the side where the light L is irradiated.

The negative electrode 320 has a second substrate 322, a second conductive layer 324 disposed on the second substrate 322, and a second photocatalyst layer 326 disposed on the second conductive layer 324. The negative electrode 320 is disposed in the bath 340 (negative electrode chamber 344) such that the second photocatalyst layer 326, the second conductive layer 324, and the second substrate 322 are arranged in this order from the side where the light L is irradiated.

Although not shown in the diagram, at least a portion of the top face (light irradiation surface) of the bath 340 is formed of a transparent member so that the light L can be irradiated into the bath 340.

The example of FIG. 4 show a case in which the light receiving surface is the first photocatalyst layer 316 and the second photocatalyst layer 326; however, it is also acceptable that the positive electrode 310 is disposed so that the first substrate 312 and the second substrate 322 become the light receiving surfaces. In this case, the positive electrode 310 may be disposed in the bath 340 (positive electrode chamber 342) so that the first substrate 312, the first conductive layer 314, and the first photocatalyst layer 316 are arranged in this order from the side where the light L is irradiated. Similarly, the negative electrode 320 may be disposed in the bath 340 (negative electrode chamber 344) so that the second substrate 322, the second conductive layer 324, and the second photocatalyst layer 326 are arranged in this order from the side where the light L is irradiated.

The example of FIG. 4 shows an embodiment in which gases are generated from the respective electrodes as a result of irradiation with light L; however, similarly to the second embodiment, an embodiment in which a voltage is applied to the respective electrodes without irradiating the light L, and thereby gases are generated from the respective electrodes is also acceptable.

### Fifth Embodiment

FIG. 5 is a lateral view schematically illustrating the electrode configuration of a device 400 as an embodiment of the device of the present invention, and in the present specification, the device 400 shown in FIG. 5 is also referred to as fifth embodiment.

The device 400 of FIG. 5 is mainly different from the device 1 of FIG. 1 in that a plurality of positive electrodes 410 and a plurality of negative electrodes 420 are disposed at different positions in a direction perpendicular to the same plane.

In FIG. 5, the same reference numerals as those in FIG. 1 will be assigned to those configurations common to FIG. 1, and the description thereof will not be repeated. Furthermore, even if some members have different reference numerals, for the parts having the same configurations as those of FIG. 1, further description will not be repeated. Other configurations shown in FIG. 1 can also be employed in the device 400 of FIG. 5, and the description and depiction thereof will not be repeated.

The positive electrode 410 and the negative electrode 420 may respectively have a substrate, a conductive layer, and a photocatalyst layer, similarly to the positive electrode 10 and the negative electrode 20 of FIG. 1. The light irradiation surface for the positive electrode 410 and the negative electrode 420 can be arranged similarly to the case of the positive electrode 10 and the negative electrode 20 of FIG. 1.

The example of FIG. 5 shows an embodiment in which gases are generated from the respective electrodes as a result of irradiation of light L; however, similarly to the second embodiment, an embodiment in which a voltage is applied to the respective electrodes without irradiating the light L, and thereby gases are generated from the respective electrodes is also acceptable.

### Examples

Hereinafter, the present invention will be described in detail using Examples. However, the present invention is not intended to be limited to this.

[Production of Polymer Membrane]

A polymer film-forming composition obtained by mixing the various components so as to have the composition shown in Table 1 was poured into a mold, the polymer film-forming composition was left to stand for 1 hour at 60° C., and thereby the monomers were polymerized. In this manner, polymer membranes 1 to 18 having a film thickness of 1 mm were obtained. The polymer membranes 1 to 18 were all in a gel state.

As a polymer membrane 19, NAFION (registered trademark) 117 (manufactured by DuPont de Nemours, Inc., film thickness 0.2 mm, a fluorine-containing polymer having sulfonic acid in a side chain) was prepared.

The components that are incorporated into the polymer film-forming compositions in Table 1 are as follows. In Table 1, with regard to the item of “Type” of “Monofunctional monomer”, numerical values shown in the parentheses represent the mass ratio of the monofunctional monomers used.

### (Monofunctional Monomer)

Acrylamide
HEMA (2-hydroxyethyl methacrylate)

(Polymer)
PVP (polyvinylpyrrolidone)
PVA (manufactured by Japan Vam & Poval Co., Ltd., modified polyvinyl alcohol

### (Hydrophilic Poval))

(Polyfunctional Monomer)
Polyfunctional monomer 1 (N,N-methylenebisacrylamide)
Polyfunctional monomer 2 (triethylene glycol dimethacrylate)

(Other Components)
Polymerization initiator 1 (ammonium peroxodisulfate)
TEMED (tetramethylethylenediamine, polymerization accelerator)
Water (pure water)

[Physical Properties of Polymer Membrane]

<Moisture Content>

The moisture content of each polymer membrane was measured according to the above-described formula, based on the mass obtained at the time of immersing the polymer membrane in pure water (25° C.) for 24 hours (mass of the polymer membrane after immersion) and the mass obtained after drying the polymer membrane after immersion in a vacuum at room temperature (25° C.) for 24 hours (mass of the polymer membrane after drying). The results are presented in Table 1.

<Handleability>

After each polymer membrane was immersed in pure water (25° C.) for 24 hours, a cylinder having a diameter of 5 mmφ was pushed into each polymer membrane, and the force required to break each polymer membrane was measured.

The case in which the force required for breaking was 500 g or more was rated as “A”; the case in which the force was 100 g or more and less than 500 g was rated as “B”; and the case in which the force was less than 100 g was rated as “C”. As the force required for breaking is larger, the handleability of the polymer membrane is superior. The results are presented in Table 1.

<Light Transmittance>

After each polymer membrane was immersed in pure water (25° C.) for 24 hours, the light transmittance of the polymer membrane in a swollen state in the wavelength range of 300 to 800 nm was measured. Specifically, a white plate was attached to a surface of the polymer membrane, the surface being on the opposite side of the irradiation surface, and the light transmittance was measured using an integrating sphere by means of an ultraviolet-visible-near-red spectrophotometer (manufactured by JASCO Corporation, product name “V-670”).

The case in which the transmittance in the wavelength range of 300 to 800 nm was 80% or higher was rated as “A”; and the case in which the transmittance was lower than 80% was rated as “B”. The results are presented in Table 1.

In addition, when the transmittance was 80% or higher, it was transparent even under visual observation. On the other hand, in a case in which the transmittance is lower than 80%, a polymer membrane which was visually recognized to be cloudy is described as “Cloudy” in the table, together with the evaluation result.

<Surface State of Polymer Membrane>

Using a scanning electron microscope (product name “SU8020”, manufactured by Hitachi High-Technologies Corporation), images obtained by magnifying the surfaces of the polymer membranes 1 to 18 at a magnification ratio of 50,000 times were observed, and no pores were found in any of the polymer membranes, while it was found that the polymer membranes were non-porous.

<Ion Exchange Capacity of Polymer Membrane>

The ion exchange capacity of each polymer membrane was calculated as follows.

First, each polymer membrane was immersed in pure water (25° C.) for 24 hours, subsequently the polymer membrane in a swollen state was immersed in a 10 mass % aqueous solution of HNO₃ at room temperature (25° C.) for 24 hours, and thus the polymer membrane was made into a completely acid type (H⁺ type). Subsequently, the polymer membrane that had been made into the acid type was washed by immersing the polymer membrane in pure water (25° C.) for 24 hours, subsequently the polymer membrane after washing was immersed in 20 mL of a 2 M aqueous solution of NaCl for 24 hours or more to convert the polymer membrane into a sodium type (Na⁺ type), and substituted H⁺ was neutralized and titrated with a 1 M aqueous solution of NaOH. Thus, the amount of ion exchange groups was determined. A phenolphthalein solution was used as an indicator.

Then, the ion exchange capacity [meq/g] of each polymer membrane was calculated by the following formula. The results are presented in Table 1. It is obvious that the polymer membranes of Examples 1 to 12 in Table 1 do not have an ion exchange group and have an ion exchange capacity of 0. Therefore, in Examples 1 to 12, measurement of the ion exchange capacity was not carried out (in Table 1, it was described as “-”).

Ion exchange capacity of polymer membrane [meq/g]=(Concentration of dropped aqueous solution of NaOH [mmol/cm³])×(volume of dropped aqueous solution of NaOH [cm³])/(dry mass of polymer membrane [g])

[Measurement of Increment of Electrolysis Voltage]

An H-type electrochemical cell was prepared as a device having a structure according to FIG. 2 described above. Pt wire electrodes were disposed respectively as a positive electrode and a negative electrode of the H-type electrochemical cell. Each of the polymer membranes 1 to 19 was disposed between the positive electrode and the negative electrode so as not to come into contact with the negative electrode and the positive electrode. Then, the positive electrode chamber in which the positive electrode was disposed and the negative electrode chamber in which the negative electrode was disposed were filled with electrolytic solutions (borate buffer solutions) having the same composition, and the positive electrode, the negative electrode, and the polymer membrane were immersed in the electrolytic solution.

Next, a current of 8 mA/cm² was caused to flow through the polymer membrane by means of a power supply connected to the positive electrode and the negative electrode, and the voltage at this time (hereinafter, also referred to as “voltage at the time when the polymer membrane was installed”) was measured.

Then, the difference between the voltage at the time when the polymer membrane was installed and the voltage in a state in which the polymer membrane was not installed [(voltage at the time when the polymer membrane was installed)−(voltage in a state in which the polymer membrane was not installed)] was calculated, and this value was designated as an increment of the electrolysis voltage.

The evaluation results are presented in Table 1.

TABLE 1

| | | Composition of polymer film-forming composition | | | | | | | |
|---|---|---|---|---|---|---|---|---|---|
| | | | | | | | | Polymerization | |
| | | | | | | | | initiator | |
| | | | | | | | | | Concentration of |
| | | Monofunctional | | | | Polyfunctional | | | polymerization |
| | Type of | monomer | | Polymer | | monomer | | | initiator in 10 |
| | polymer | | Content | | Content | | Content | | mass % aqueous |
| | membrane | Type | (mass %) | Type | (mass %) | Type | (mass %) | Type | solution (ml) |
| Example 1 | Polymer | Acrylamide | 20 | — | — | Polyfunctional | 1.5 | Polymerization | 0.2 |
| | membrane 1 | | | | | monomer 1 | | initiator 1 | |
| Example 2 | Polymer | Acrylamide | 40 | — | — | Polyfunctional | 1.5 | Polymerization | 0.2 |
| | membrane 2 | | | | | monomer 1 | | initiator 1 | |
| Example 3 | Polymer | Acrylamide | 60 | — | — | Polyfunctional | 1.5 | Polymerization | 0.2 |
| | membrane 3 | | | | | monomer 1 | | initiator 1 | |
| Example 4 | Polymer | Acrylamide | 20 | — | — | Polyfunctional | 1.5 | Polymerization | 0.2 |
| | membrane 4 | | | | | monomer 2 | | initiator 1 | |
| Example 5 | Polymer | Acrylamide | 40 | — | — | Polyfunctional | 1.5 | Polymerization | 0.2 |
| | membrane 5 | | | | | monomer 2 | | initiator 1 | |
| Example 6 | Polymer | Acrylamide | 60 | — | — | Polyfunctional | 1.5 | Polymerization | 0.2 |
| | membrane 6 | | | | | monomer 2 | | initiator 1 | |
| Example 7 | Polymer | HEMA | 20 | — | — | Polyfunctional | 1.5 | Polymerization | 0.2 |
| | membrane 7 | | | | | monomer 2 | | initiator 1 | |
| Example 8 | Polymer | HEMA | 40 | — | — | Polyfunctional | 1.5 | Polymerization | 0.2 |
| | membrane 8 | | | | | monomer 2 | | initiator 1 | |
| Example 9 | Polymer | HEMA | 60 | — | — | Polyfunctional | 1.5 | Polymerization | 0.2 |
| | membrane 9 | | | | | monomer 2 | | initiator 1 | |
| Example 10 | Polymer | HEMA/ | 20 | — | — | Polyfunctional | 1.5 | Polymerization | 0.2 |
| | membrane 10 | acrylamide | | | | monomer 2 | | initiator 1 | |
| | | (50/50) | | | | | | | |
| Example 11 | Polymer | HEMA/ | 40 | — | — | Polyfunctional | 1.5 | Polymerization | 0.2 |
| | membrane 11 | acrylamide | | | | monomer 2 | | initiator 1 | |
| | | (50/50) | | | | | | | |
| Example 12 | Polymer | HEMA/ | 60 | — | — | Polyfunctional | 1.5 | Polymerization | 0.2 |
| | membrane 12 | acrylamide | | | | monomer 2 | | initiator 1 | |
| | | (50/50) | | | | | | | |
| Example 13 | Polymer | HEMA | 40 | PVP | 0.1 | Polyfunctional | 1.5 | Polymerization | 0.2 |
| | membrane 13 | | | | | monomer 2 | | initiator 1 | |
| Example 14 | Polymer | HEMA | 40 | PVP | 1 | Polyfunctional | 1.5 | Polymerization | 0.2 |
| | membrane 14 | | | | | monomer 2 | | initiator 1 | |
| Example 15 | Polymer | HEMA | 40 | PVP | 5 | Polyfunctional | 1.5 | Polymerization | 0.2 |
| | membrane 15 | | | | | monomer 2 | | initiator 1 | |
| Example 16 | Polymer | HEMA | 40 | PVA | 0.1 | Polyfunctional | 1.5 | Polymerization | 0.2 |
| | membrane 16 | | | | | monomer 2 | | initiator 1 | |
| Example 17 | Polymer | HEMA | 40 | PVA | 1 | Polyfunctional | 1.5 | Polymerization | 0.2 |
| | membrane 17 | | | | | monomer 2 | | initiator 1 | |
| Example 18 | Polymer | HEMA | 40 | PVA | 5 | Polyfunctional | 1.5 | Polymerization | 0.2 |
| | membrane 18 | | | | | monomer 2 | | initiator 1 | |
| Comparative | Polymer | — | — | — | — | — | — | — | — |
| Example 1 | membrane 19 | | | | | | | | |

| Composition of polymer film-forming composition | | |
|---|---|---|
| | | Evaluation |
| Polymerization | Physical properties of | results |

| | accelerator | | | | polymer membrane | | | | Increment of |
|---|---|---|---|---|---|---|---|---|---|
| | | Content | Solvent | | Moisture | | | Ion exchange | electrolysis |
| | Type | (μl) | Type | Content | conient (%) | Handleabilily | Transmittance | capacity [meq/g] | voltage (V) |
| Example 1 | TEMED | 20 | Water | Balance | 80 | A | A | — | 0.01 |
| Example 2 | TEMED | 20 | Water | Balance | 75 | A | A | — | 0.02 |
| Example 3 | TEMED | 20 | Water | Balance | 68 | A | A | — | 0.03 |
| Example 4 | TEMED | 20 | Water | Balance | 80 | A | A | — | 0.01 |
| Example 5 | TEMED | 20 | Water | Balance | 75 | A | A | — | 0.02 |
| Example 6 | TEMED | 20 | Water | Balance | 68 | A | A | — | 0.04 |
| Example 7 | TEMED | 20 | Water | Balance | 75 | A | B (cloudy) | — | 0.06 |
| Example 8 | TEMED | 20 | Water | Balance | 58 | A | A | — | 0.16 |
| Example 9 | TEMED | 20 | Water | Balance | 40 | A | A | — | 0.18 |
| Example 10 | TEMED | 20 | Water | Balance | 75 | A | A | — | 0.01 |
| Example 11 | TEMED | 20 | Water | Balance | 70 | A | A | — | 0.01 |
| Example 12 | TEMED | 20 | Water | Balance | 60 | A | A | — | 0.03 |
| Example 13 | TEMED | 20 | Water | Balance | 65 | A | A | 1.7 | 0.01 |
| Example 14 | TEMED | 20 | Water | Balance | 75 | A | A | 1.9 | 0.03 |
| Example 15 | TEMED | 20 | Water | Balance | 85 | B | A | 2.6 | 0.12 |
| Example 16 | TEMED | 20 | Water | Balance | 62 | A | A | 1.5 | 0.01 |
| Example 17 | TEMED | 20 | Water | Balance | 70 | A | A | 1.8 | 0.02 |
| Example 18 | TEMED | 20 | Waler | Balance | 82 | B | A | 2.3 | 0.03 |
| Comparative | — | — | — | — | 12 | A | A | 6.8 | 0.20 |
| Example 1 | | | | | | | | | |

As shown in Table 1, it was found that in a case in which a polymer membrane having a moisture content of 40% or higher was used (Examples 1 to 18), the increase in the electrolysis voltage was small compared to the case in which a polymer membrane having a moisture content of lower than 40% was used (Comparative Example 1).

[Measurement of Concentration of Oxygen Incorporation into Negative Electrode Chamber]

The concentration of oxygen incorporation into the negative electrode chamber was measured using the device 200 shown in FIG. 3.

Specifically, in the device 200 of FIG. 3, Pt wire electrodes were used as the positive electrode 210 and the negative electrode 220, the above-mentioned polymer membranes 1 to 19 were used as the polymer membrane 30, and a borate buffer (K₃BO₃+KOH: pH 9.0) was used as the electrolytic solution S.

The ratio of the area of the portion in which the polymer membrane 30 comes into contact with the electrolytic solution S with respect to the area of the portion in which the positive electrode 210 and the negative electrode 220 come into contact with the electrolytic solution S, was 1.

The device 200 of FIG. 3 prepared in this manner was driven using a power supply (not shown in the diagram) connected to the positive electrode 210 and the negative electrode 220, thereby decomposition of the electrolytic solution S was performed, and thus gases were generated from the respective electrodes. Then, the concentration of oxygen included in the gas in the negative electrode chamber 144 was measured using the gas chromatography mass spectrometer 190.

In Example 2, Example 8, Example 17, and Comparative Example 1, the oxygen concentrations in the gas generated from the negative electrode chamber 144 were 0.4% by mass, 0.4% by mass, 0.3% by mass, and 0.6 mass % in this order. In Examples 1, 3 to 7, 9 to 16, and 18, the oxygen concentration in the gas generated from the negative electrode chamber 144 was less than 0.6% by mass in all cases.

As such, it was found that in a case in which a polymer membrane having a moisture content of 40% or higher is used (Examples 1 to 18), the gas separation performance is excellent compared to the case of using a polymer membrane having a moisture content of lower than 40% (Comparative Example 1).

### EXPLANATION OF REFERENCES

1, 100, 200, 300, 400: Device
10, 110, 210, 310, 410: Positive electrode
12, 312: First substrate
14, 314: First conductive layer
16, 316: First photocatalyst layer
20, 120, 220, 320, 420: Negative electrode
22, 322: Second substrate
24, 324: Second conductive layer
26, 326: Second photocatalyst layer
30: Polymer membrane
32: Support
40, 140, 240, 340: Bath
42, 142, 342: Positive electrode chamber
44, 144, 344: Negative electrode chamber
46: Transparent member
50, 150: Conducting wire
62: First pipe
64: Second pipe
102a, 102b: Tank
104: Pump
152: Power supply
170a, 170b: Supply pipe
180a, 180b: Discharge pipe
190: Gas chromatography mass spectrometer
S: Electrolytic solution
L: Light
B: Horizontal surface
φ: Angle

What is claimed is:

1. A water splitting device for generating gases from a positive electrode and a negative electrode, the water splitting device comprising:
a bath to be filled with an electrolytic aqueous solution;
the positive electrode and the negative electrode disposed in the bath, and
a polymer membrane through which ions included in the electrolytic aqueous solution can permeate and that is disposed between the positive electrode and the negative electrode in order to separate the electrolytic aqueous solution filling the bath into the positive electrode side and the negative electrode side,
wherein the positive electrode and the negative electrode are both installed at a predetermined distance from the polymer membrane,
the polymer membrane has a moisture content of 40% or more, and
the ions included in the electrolytic aqueous solution can permeate the polymer membrane and freely enter and exit the positive electrode side and the negative electrode side.

2. The water splitting device according to claim 1, wherein the water splitting device is a device generating gases from the positive electrode and the negative electrode by irradiating the positive electrode and the negative electrode with light.

3. The water splitting device according to claim 1, wherein the moisture content of the polymer membrane is 60% or more.

4. The water splitting device according to claim 1, wherein the polymer membrane is obtained using a polymer film-forming composition including a component from which a main component of the polymer membrane is derived; and at least one of a monomer or a polymer other than the component from which the main component is derived, and
a sum of the contents of the monomer and the polymer is 15% by mass or less with respect to the total mass of the polymer film-forming composition.

5. The water splitting device according to claim 1, wherein the polymer membrane is supported by a support.

6. The water splitting device according to claim 1, wherein the proportion of an area of a portion in which the polymer membrane comes into contact with the electrolytic aqueous solution with respect to an area of a portion in which the positive electrode or the negative electrode comes into contact with the electrolytic aqueous solution is 0.5 or more.

7. The water splitting device according to claim 1, wherein the polymer membrane is non-porous.

8. The water splitting device according to claim 1, wherein a polymer as a main component of the polymer membrane has a hydrophilic group.

9. The water splitting device according to claim 1, wherein the water splitting device is a device that irradiates the positive electrode and the negative electrode with light and thereby generates gases from the positive electrode and the negative electrode,
the positive electrode, the polymer membrane, and the negative electrode are arranged in series along the traveling direction of the light to be irradiated, and
the light transmittance of the polymer membrane in a direction in series with the traveling direction of the light is 80% or higher in the wavelength range of 300 to 800 nm.

10. The water splitting device according to claim 9, wherein the positive electrode and the negative electrode have different absorption edge wavelengths of the light, and
an absorption edge wavelength of the light of the negative electrode is longer than an absorption edge wavelength of the light of the positive electrode.

11. The water splitting device according to claim 1, wherein at least one of the positive electrode or the negative electrode has a photocatalyst layer, and
the photocatalyst layer includes at least one material selected from the group consisting of BiVO₄, Ta₃N₅, BaTaO₂N, and a CIGS compound semiconductor.

12. The water splitting device according to claim 1, wherein a gas generated from the positive electrode is oxygen, and a gas generated from the negative electrode is hydrogen.

13. The water splitting device according to claim 1, wherein the polymer membrane has a three-dimensional network structure.

14. The water splitting device according to claim 2, wherein the moisture content of the polymer membrane is 60% or more.

15. The water splitting device according to claim 2, wherein the polymer membrane is obtained using a polymer film-forming composition including a component from which a main component of the polymer membrane is derived; and at least one of a monomer or a polymer other than the component from which the main component is derived, and
a sum of the contents of the monomer and the polymer is 15% by mass or less with respect to the total mass of the polymer film-forming composition.

16. The water splitting device according to claim 3, wherein the polymer membrane is obtained using a polymer film-forming composition including a component from which a main component of the polymer membrane is derived; and at least one of a monomer or a polymer other than the component from which the main component is derived, and
a sum of the contents of the monomer and the polymer is 15% by mass or less with respect to the total mass of the polymer film-forming composition.

17. The water splitting device according to claim 14, wherein the polymer membrane is obtained using a polymer film-forming composition including a component from which a main component of the polymer membrane is derived; and at least one of a monomer or a polymer other than the component from which the main component is derived, and
a sum of the contents of the monomer and the polymer is 15% by mass or less with respect to the total mass of the polymer film-forming composition.

18. The water splitting device according to claim 2, wherein the polymer membrane is supported by a support.

19. The water splitting device according to claim 3, wherein the polymer membrane is supported by a support.

20. The water splitting device according to claim 4, wherein the polymer membrane is supported by a support.
